(19) United States
(12) Patent Application Publication
(10) Pub. No.: US 2021/0120185 A1
(43) Pub. Date: Apr. 22, 2021

(54) MONITORING SYSTEM, MONITORING METHOD, AND STORAGE MEDIUM

(71) Applicant: TOYOTA JIDOSHA KABUSHIKI KAISHA, Toyota-shi (JP)

(72) Inventors: Yasutaka ETOU, Okazaki-shi (JP); Tomohito MATSUOKA, Nagoya-shi (JP); Nobuyuki TOMATSU, Nagoya-shi (JP); Masanobu OHMI, Kasugai-shi (JP); Manabu YAMAMOTO, Toyota-shi (JP); Suguru WATANABE, Nagoya-shi (JP); Yohei TANIGAWA, Toyota-shi (JP)

(73) Assignee: TOYOTA JIDOSHA KABUSHIKI KAISHA, Toyota-shi (JP)

(21) Appl. No.: 16/983,305

(22) Filed: Aug. 3, 2020

(30) Foreign Application Priority Data
Oct. 21, 2019 (JP) 2019-192054

(51) Int. Cl. H04N 5/232; H04N 7/18; H04N 5/225; G06K 9/00; G05D 1/00

(52) U.S. Cl. CPC H04N 5/23299; H04N 7/181; H04N 5/2253; H04N 5/247; H04N 5/23238; G05D 1/0094; G06K 9/00664

(57) ABSTRACT

A monitoring method includes acquiring an image captured by a monitoring camera, analyzing the image captured by the monitoring camera, specifying an area that needs information from the analysis result, transmitting, to a mobile robot, a dispatch instruction to the specified area, acquiring an image captured by a camera of the mobile robot, and analyzing the image captured by the camera of the mobile robot.

### CROSS-REFERENCE TO RELATED APPLICATION

This application claims priority to Japanese Patent Application No. 2019-192054 filed on Oct. 21, 2019, incorporated herein by reference in its entirety.

### BACKGROUND

### 1. Technical Field

The disclosure relates to a monitoring system, a monitoring method, and a storage medium using a mobile robot provided with a camera.

### 2. Description of Related Art

Japanese Unexamined Patent Application Publication No. 2007-148793 (JP 2007-148793 A) discloses a monitoring system including a mobile robot autonomously or semi-autonomously moving around a facility to be monitored, a control device for the mobile robot installed on the facility to be monitored, and a remote monitoring center, where the control device can communicate with the mobile robot and the monitoring center.

### SUMMARY

In recent years, flooding of rivers and irrigation channels has frequently occurred due to record heavy rain, and thus, systems have been constructed in which a fixed-point camera for capturing images of rivers and irrigation channels is installed and the captured images are transmitted to a monitoring center in real time. At present, observers visually monitor rivers and irrigation channels, but in the future, it is expected that occurrence of flooding of rivers and irrigation channels can be determined and even can be predicted by image analysis using artificial intelligence, and the like. In order to increase the accuracy of the determination or prediction, information acquired in the area to be monitored has to be accurate.

Therefore, an object of the disclosure is to achieve a mechanism for acquiring accurate information on an area to be monitored.

A first aspect of the disclosure relates to a monitoring system including a plurality of mobile robots and a monitoring device. The mobile robot includes a camera, a traveling controller configured to control a traveling mechanism according to a dispatch instruction transmitted from the monitoring device to cause the mobile robot to travel, and a captured image transmitter configured to transmit, to the monitoring device, an image captured by the camera together with capture-position information indicating a position where the image has been captured. The monitoring device includes a first image acquisition unit configured to acquire an image captured by a monitoring camera, a camera position holding unit configured to store an installation position of the monitoring camera, an analyzing unit configured to analyze the image acquired by first image acquisition unit, a specifying unit configured to specify an area that needs information from a result of the analysis by the analyzing unit, an instruction unit configured to transmit, to the mobile robot, a dispatch instruction to the area specified by the specifying unit, and a second image acquisition unit configured to acquire an image captured by the camera of the mobile robot and capture-position information.

A second aspect of the disclosure relates to a monitoring method. The monitoring method includes acquiring an image captured by a monitoring camera, analyzing the image captured by the monitoring camera, specifying an area that needs information from a result of the analysis, transmitting, to a mobile robot, a dispatch instruction to the specified area, acquiring an image captured by a camera of the mobile robot, and analyzing the image captured by the camera of the mobile robot.

A third aspect of the disclosure relates to a non-transitory computer readable storage medium. The non-transitory computer readable storage medium stores a computer program executable by a processor to implement the monitoring method.

According to the aspects of the disclosure, a mechanism for acquiring accurate information on the area to be monitored is achieved.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is a perspective view of a mobile robot according to an embodiment;

FIG. 1B is another perspective view of the mobile robot according to the embodiment;

FIG. 2A is a perspective view of the mobile robot in an upright standing position;

FIG. 2B is a perspective view of the mobile robot in an upright standing position;

FIG. 3 is a perspective view of the mobile robot loaded with packages;

FIG. 4A is a diagram illustrating a relative movement of a main body with respect to a traveling mechanism;

FIG. 4B is a diagram illustrating another relative movement of the main body with respect to the traveling mechanism;

FIG. 5A is a diagram illustrating a structure of the mobile robot;

FIG. 5B is a diagram illustrating the structure of the mobile robot;

FIG. 6 is a diagram illustrating functional blocks of the mobile robot;

FIG. 7 is a schematic diagram illustrating an outline of a monitoring system according to an embodiment; and

FIG. 8 is a diagram illustrating functional blocks of a monitoring device.

### DETAILED DESCRIPTION OF EMBODIMENTS

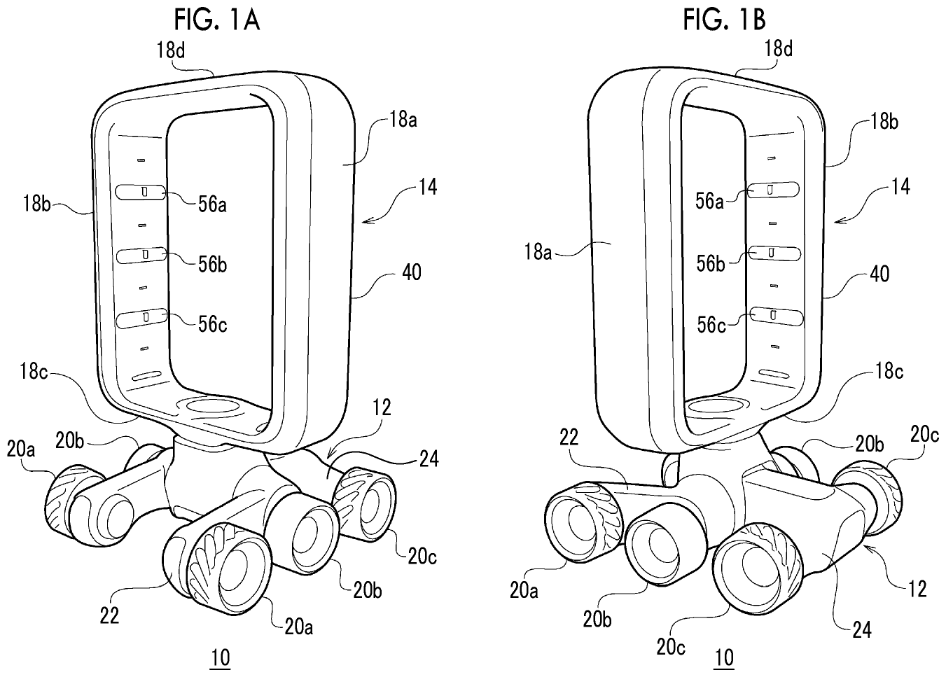

FIGS. 1A and 1B are perspective views of a mobile robot 10 of an embodiment. The height of the mobile robot 10 may be, for example, about 1 to 1.5 meters. The mobile robot 10 includes a traveling mechanism 12 having an autonomous traveling function, and a main body 14 which is supported by the traveling mechanism 12 and on which an object such as a package is loaded. The traveling mechanism 12 includes a first wheel body 22 and a second wheel body 24. The first wheel body 22 has a pair of front wheels 20a and a pair of middle wheels 20b, and the second wheel body 24 has a pair of rear wheels 20c. FIGS. 1A and 1B show a state in which front wheels 20a, middle wheels 20b, and rear wheels 20c are arranged in a straight line.

The main body 14 has a frame body 40 formed in a rectangular shape, and a housing space for loading an object such as a package is formed inside the frame body 40. The frame body 40 includes a pair of right and left side walls 18a, 18b, a bottom plate 18c connecting the pair of side walls at a lower side, and an upper plate 18d connecting the pair of side walls at an upper side. A pair of projecting strip portions (ribs) 56a, 56b, 56c (hereinafter, referred to as “projecting strip portions 56” unless otherwise distinguished) facing each other are provided on the inner surfaces of the right side wall 18a and the left side wall 18b. The main body 14 is connected to the traveling mechanism 12 to be relatively movable. The mobile robot 10 according to the embodiment has a home delivery function of loading a package, autonomously traveling to a set destination, and delivering the package to a user waiting at the destination. Hereinafter, with respect to directions of the main body 14, a direction perpendicular to the opening of the frame body 40 in a state in which the main body 14 stands upright with respect to the traveling mechanism 12 is referred to as a “front-rear direction”, and a direction perpendicular to a pair of side walls is referred to as a “right-left direction”.

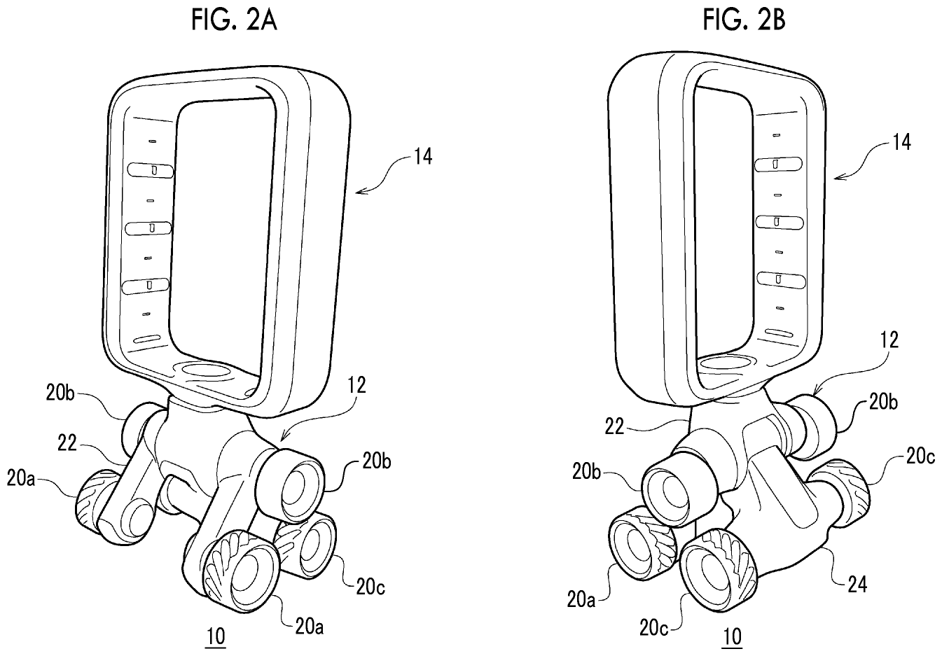

FIGS. 2A and 2B are perspective views of the mobile robot 10 of the embodiment in an upright standing position. The front wheels 20a and the rear wheels 20c in the traveling mechanism 12 gets close to each other, and the first wheel body 22 and the second wheel body 24 incline with respect to the ground contact surface, whereby the mobile robot 10 takes an upright standing position. For example, when the mobile robot 10 reaches a destination and takes the upright standing position in front of a user at the destination, the user can easily pick up the package loaded on the main body 14, which is destined for the user himself or herself.

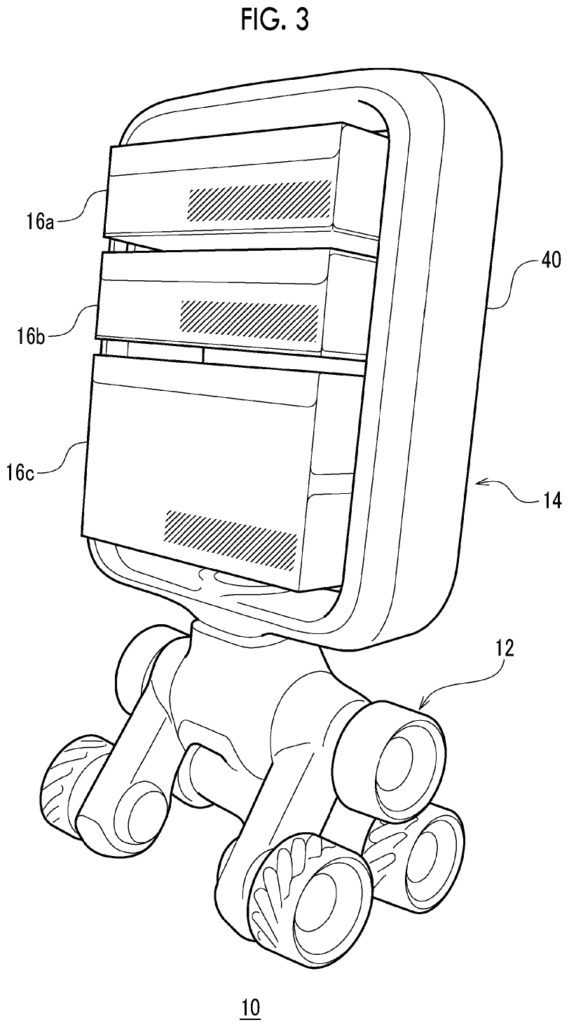

FIG. 3 is a perspective view of the mobile robot 10 in the upright standing position with packages loaded. FIG. 3 shows a state where a first package 16a, a second package 16b, and a third package 16c are loaded on the main body 14. The first package 16a, the second package 16b, and the third package 16c are loaded on or engaged with the projecting strip portions 56 formed on the inner surfaces of the right side wall 18a and the left side wall 18b, thereby being loaded on the main body 14.

Although the first package 16a, the second package 16b, the third package 16c shown in FIG. 3 have a box shape, the object loaded on the main body 14 is not limited to the box shape. For example, a container for housing the object may be loaded on projecting strip portions 56, and the object may be put in the container. Further, a hook may be provided on the inner surface of an upper plate 18d of the frame body 40, the object may be put in a bag with a handle, and the handle of the bag may be hung on the hook to hang the bag.

In addition, various things other than packages can be housed in the housing space in the frame body 40. For example, by housing a refrigerator in the frame body 40, the mobile robot 10 can function as a movable refrigerator. Furthermore, by housing, in the frame body 40, a product shelf loaded with products, the mobile robot 10 can function as a moving store.

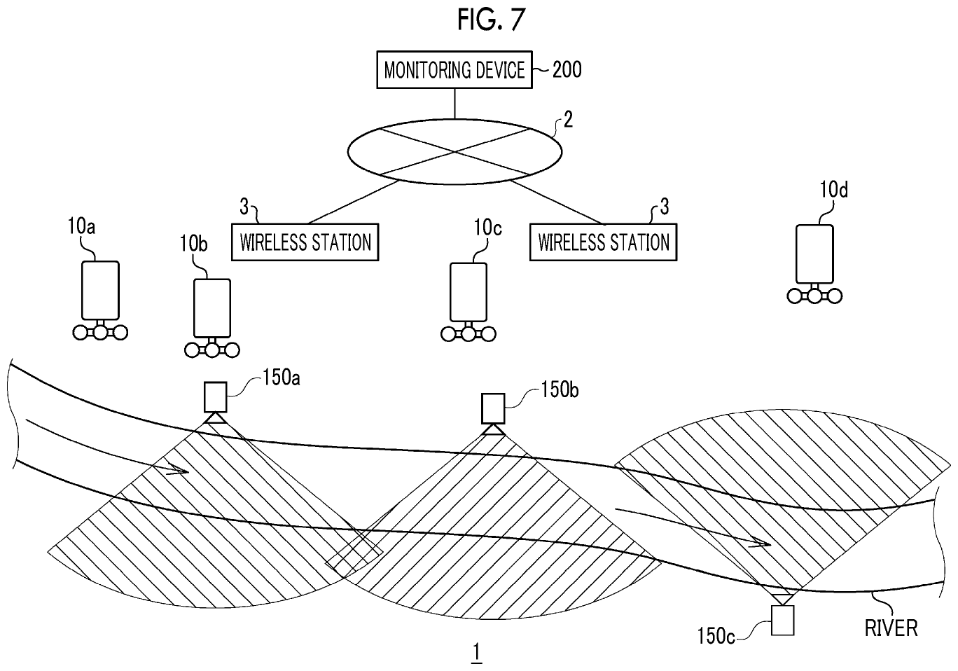

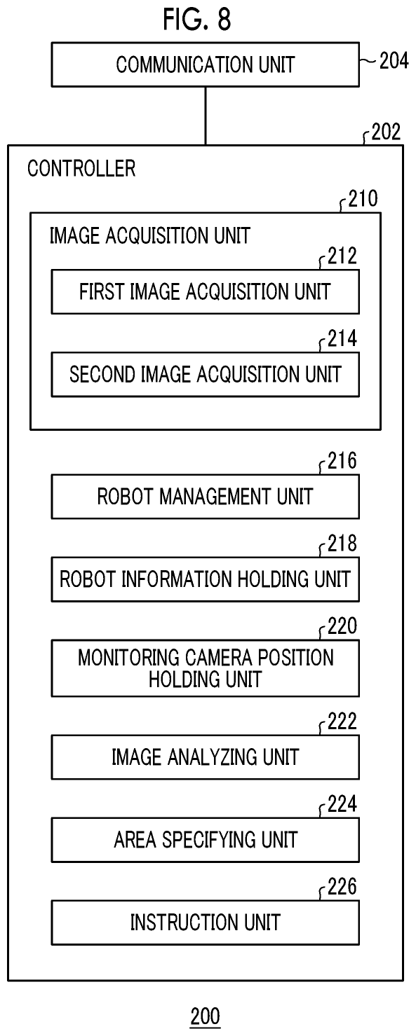

The mobile robot 10 according to the embodiment includes a camera, and functions as an image-capturing robot that rushes to an area that needs accurate information, such as an area where a disaster is likely to occur, and transmits an image captured by the camera to a monitoring device. The monitoring device analyzes the video captured by the monitoring camera, which is a fixed-point camera, and constantly monitors the state of a road or a river. When determination is made that accurate information is needed in the area to be monitored by the monitoring camera and the surrounding area, the monitoring device directs the mobile robot 10 to the area and causes the mobile robot 10 to capture images of the area. The operation of the mobile robot 10 as an image-capturing robot will be described with reference to FIGS. 7 and 8.

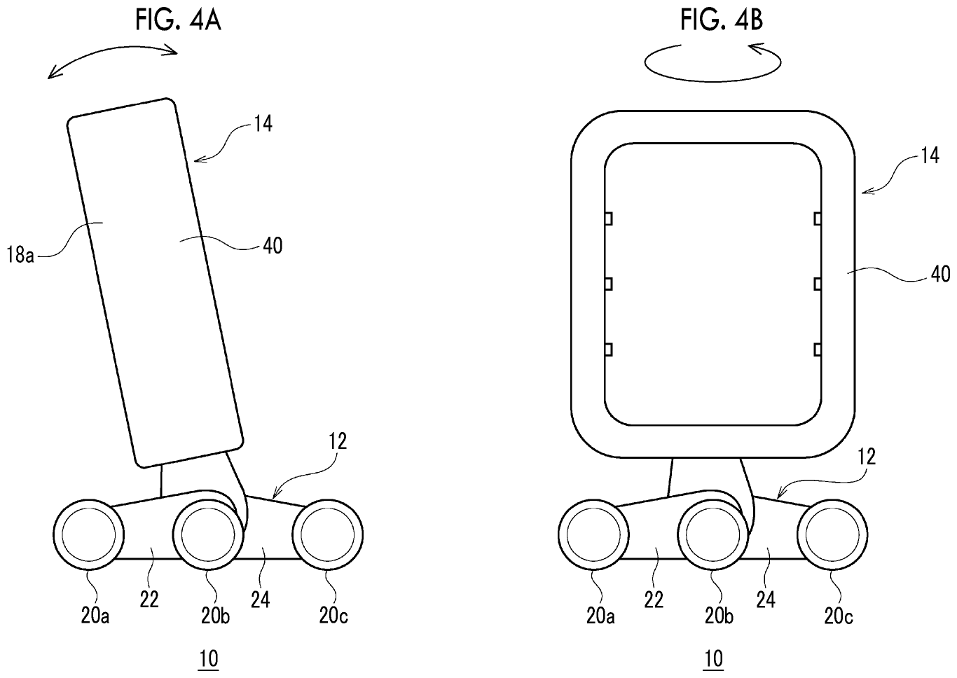

FIGS. 4A and 4B are diagrams illustrating relative movements of the main body 14 with respect to the traveling mechanism 12. FIG. 4A shows a state where the side wall of the frame body 40 is inclined with respect to the vertical direction. The frame body 40 is supported to be relatively rotatable with respect to the traveling mechanism 12 by a connecting shaft extending in the right-left direction, and can be inclined in any of the front-rear directions.

FIG. 4B shows a state in which the frame body 40 is rotated by about 90 degrees around a vertical axis. The frame body 40 is supported to be relatively rotatable with respect to the traveling mechanism 12 by a connecting shaft extending in a direction perpendicular to the traveling mechanism 12, and the frame body 40 rotates as shown in FIG. 4B since the frame body 40 and the traveling mechanism 12 rotates relatively to each other around the connecting shaft. The frame body 40 may be rotatable 360 degrees.

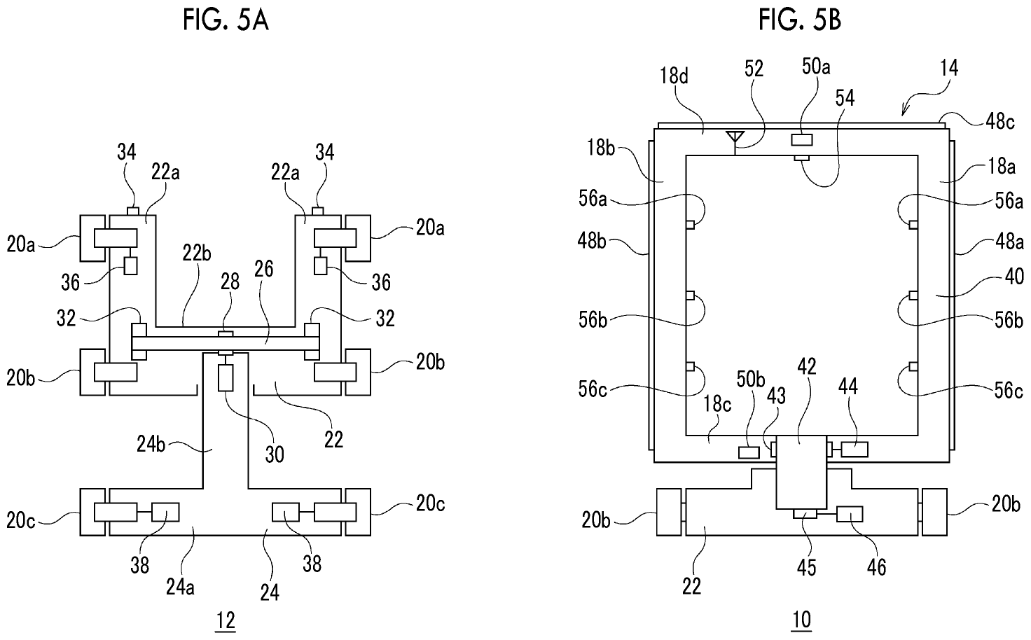

FIGS. 5A and 5B are diagrams illustrating the structure of the mobile robot 10. FIG. 5A shows the structure of the traveling mechanism 12, and FIG. 5B mainly shows the structure of the main body 14. Actually, a power supply and a controller are provided in the traveling mechanism 12 and the main body 14, but are omitted in FIGS. 5A and 5B.

As shown in FIG. 5A, the traveling mechanism 12 includes front wheels 20a, middle wheels 20b, rear wheels 20c, a first wheel body 22, a second wheel body 24, a shaft 26, a coupling gear 28, a standing actuator 30, shaft supports 32, object detection sensors 34, front wheel motors 36 and rear wheel motors 38.

The first wheel body 22 has a pair of side members 22a and a cross member 22b connecting the side members 22a and extending in the vehicle width direction. The side members 22a are provided to extend from both ends of the cross member 22b in a direction perpendicular to the cross member 22b. The front wheels 20a is provided at the positions of the front ends of the side members 22a, respectively, and the middle wheels 20b is provided at the positions of both ends of the cross member 22b. A front wheel motor 36 that rotates a wheel shaft is provided on each of the front wheels 20a.

The second wheel body 24 has a cross member 24a extending in the vehicle width direction, and a connecting member 24b extending from a center position of the cross member 24a in a direction perpendicular to the cross member 24a. The connecting member 24b is inserted into the cross member 22b of the first wheel body 22, and is connected to the first wheel body 22 to be relatively rotatable. The rear wheels 20c are provided at both ends of the cross member 24a, respectively.

The rear wheel motors 38 for rotating a wheel shaft is provided on the rear wheels 20c, respectively. The front wheels 20a and the rear wheels 20c can be independently rotated by the respective motors, and the traveling mechanism 12 can turn right or left depending on the difference in the amount of rotation between the right and left wheels.

The shaft 26 extending in the vehicle width direction and the shaft supports 32 for supporting both ends of the shaft 26 are provided inside the cross member 22b. The connecting member 24b of the second wheel body 24 is rotatably connected to the shaft 26 by the coupling gear 28. The standing actuator 30 can rotate the connecting member 24b around the shaft 26. The first wheel body 22 and the second wheel body 24 can be relatively rotated by the driving of the standing actuator 30 to take the upright standing position shown in FIGS. 2A and 2B and to return to the horizontal position shown in FIGS. 1A and 1B from the upright standing position.

The traveling mechanism 12 has a rocker bogie structure capable of traveling on a step on a road or the like. The shaft 26 that connects the first wheel body 22 and the second wheel body 24 is offset from the wheel shaft of the middle wheels 20b, and is positioned between the wheel shaft of the front wheels 20a and the wheel shaft of the middle wheels 20b in a direction perpendicular to the vehicle width. Thus, the first wheel body 22 and the second wheel body 24 can be bent to the road surface shape during traveling, with reference to the shaft 26 as a supporting point.

The object detection sensors 34 are provided on the first wheel body 22 and detect objects in the traveling direction. The object detection sensor 34 may be a millimeter wave radar, an infrared laser, a sound wave sensor, or the like, or may be a combination thereof. The object detection sensor 34 may be provided at various positions on the first wheel body 22 and the second wheel body 24 to make a detection of a rearward or lateral object, in addition to the front portion of the first wheel body 22.

As shown in FIG. 5B, the mobile robot 10 includes the frame body 40, the connecting shaft 42, outer peripheral teeth 43, a rotary actuator 44, a connecting shaft 45, a tilt actuator 46, a first camera 50a, a second camera 50b, and a communication unit 52. In the frame body 40, a right-side display 48a, a left-side display 48b, and an upper-side display 48c (hereinafter, referred to as “displays 48” unless otherwise distinguished), a hook 54, the first projecting strip portions 56a, the second projecting strip portions 56b, and the third projecting strip portions 56c are provided. For convenience of description, in FIG. 5B, the connecting shaft 42, the outer peripheral teeth 43, the rotary actuator 44, the connecting shaft 45, and the tilt actuator 46 are simplified and integrally shown. However, the connecting shaft 42, the outer peripheral teeth 43, and the rotary actuator 44 may be provided separately from the connecting shaft 45 and the tilt actuator 46.

The projecting strip portions 56 are provided to project out from the inner surfaces of the right side wall 18a and the left side wall 18b to load a package or the like. The hook 54 for hanging a package is formed on the inner surface of the upper plate 18d of the frame body 40. The hook 54 may always be exposed from the inner surface of the upper plate of the frame body 40, but may be provided to be housed in the inner surface of the upper plate such that the hooks 54 can be taken out as necessary.

The right-side display 48a is provided on the outer surface of the right side wall 18a, the left-side display 48b is provided on the outer surface of the left side wall 18b, and the upper-side display 48c is provided on an outer surface of the upper plate 18d. The bottom plate 18c and the upper plate 18d are provided with a first camera 50a and a second camera 50b (referred to as “camera 50” unless otherwise distinguished). It is desirable that the mobile robot 10 of the embodiment is mounted with a camera in addition to the first camera 50a and the second camera 50b to capture images over 360 degrees around the frame body 40. The communication unit 52 is further provided on the upper plate 18d, and the communication unit 52 can communicate with an external server device through a wireless communication network.

The bottom plate 18c is rotatably attached to the outer peripheral teeth 43 of the connecting shaft 42 through a gear (not shown) on the rotary actuator 44, and is connected to the first wheel body 22 by the connecting shaft 42. The rotary actuator 44 rotates the frame body 40 to the connecting shaft 42 by relatively rotating the outer peripheral teeth 43 and the gear. As shown in FIG. 4B, the rotary actuator 44 allows the frame body 40 to be rotated.

The tilt actuator 46 rotates the connecting shaft 45 such that the connecting shaft 42 is inclined with respect to the vertical direction. The connecting shaft 45 extending in the right-left direction is provided integrally with the lower end of the connecting shaft 42, and the tilt actuator 46 rotates the connecting shaft 45 to implement the tilting motion of the connecting shaft 42. By tilting the connecting shaft 42, the tilt actuator 46 can tilt the frame body 40 in the front-rear direction as shown in FIG. 4A.

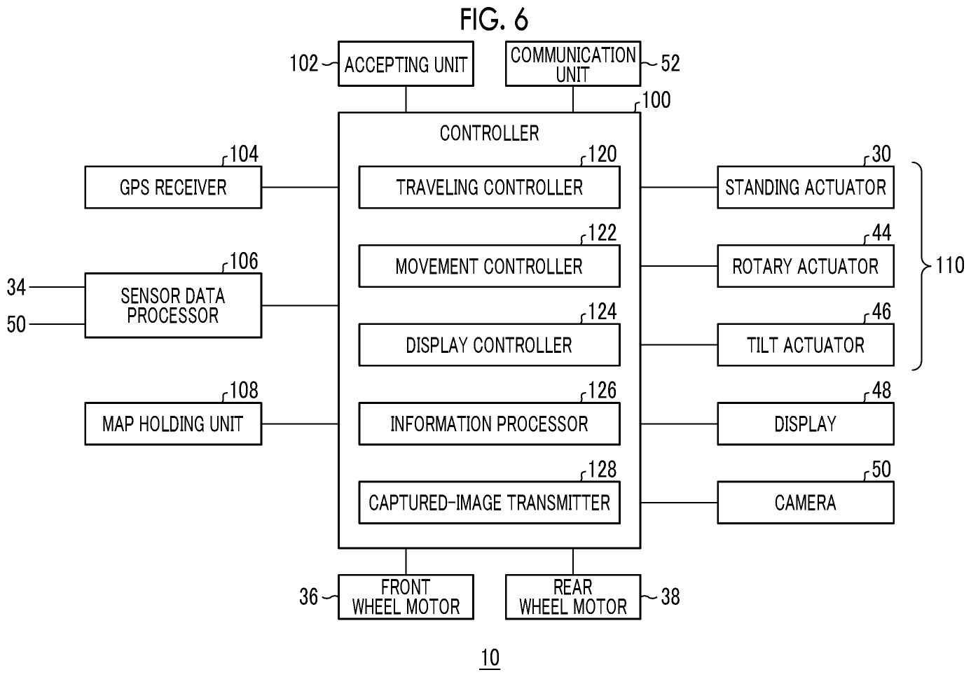

FIG. 6 shows functional blocks of the mobile robot 10. The mobile robot 10 includes a controller 100, an accepting unit 102, a communication unit 52, a global positioning system (GPS) receiver 104, a sensor data processor 106, a map holding unit 108, an actuator mechanism 110, a display 48, a camera 50, front wheel motors 36, and a rear wheel motors 38. The controller 100 includes a traveling controller 120, a movement controller 122, a display controller 124, an information processor 126 and a captured image transmitter 128, and the actuator mechanism 110 includes the standing actuator 30, a rotary actuator 44, and a tilt actuator 46. The communication unit 52 has a wireless communication function, can communicate with a communication unit of another mobile robot 10 from vehicle to vehicle, and can receive information transmitted from the monitoring device in the monitoring system. The GPS receiver 104 detects a current position based on a signal from a satellite.

In FIG. 6, each of the elements described as functional blocks that perform various processes may be configured to include a circuit block, a memory, or another LSI in terms of hardware, and is implemented by a program, or the like loaded into the memory in terms of software. Therefore, it is to be understood by those skilled in the art that these functional blocks can be implemented in various forms by hardware, software, or a combination thereof, and the disclosure is not limited thereto.

The map holding unit 108 holds map information indicating a road position. The map holding unit 108 may hold not only the road position but also map information indicating a passage position on each floor in a multi-story building such as a commercial facility.

The mobile robot 10 has a plurality of action modes, and acts in the set action mode. Among the action modes, the basic action mode is an action mode in which the robot autonomously travels to a destination and delivers a package to a user waiting at the destination. Hereinafter, the basic action mode of the mobile robot 10 will be described.

Basic Action Mode

The mobile robot 10 is waiting at a pick-up site, and when a staff member at the pick-up site inputs a delivery destination, the mobile robot 10 travels autonomously to the input delivery destination. The traveling route may be determined by the mobile robot 10, or may be set by an external server device. The input of the delivery destination is performed by a predetermined wireless input tool, and when the staff member inputs the delivery destination from the wireless input tool, the communication unit 52 receives the delivery destination and notifies the traveling controller 120 of the delivery destination. The wireless input tool may be a dedicated remote controller, or may be a smartphone on which a dedicated application is installed.

The mobile robot 10 includes an interface for inputting a delivery destination, and the staff member may input the delivery destination from the interface. For example, when the display 48 is a display having a touch panel, the display controller 124 may display a delivery destination input screen on the display 48, and the staff member may input a delivery destination from the delivery destination input screen. When the accepting unit 102 accepts the touch operation on the touch panel, the information processor 126 specifies the delivery destination from the touch position and notifies the traveling controller 120. When the staff member at the pick-up site loads the package on the frame body 40 and inputs the delivery destination, and then instructs the mobile robot 10 to start the delivery, the traveling controller 120 starts traveling to the set delivery destination. The staff member may set a plurality of delivery destinations and load the package for each delivery destination in the housing space of the frame body 40.

The frame body 40 is provided with a mechanism for locking (fixing) the loaded package to the frame body 40. While the mobile robot 10 is traveling, the package is fixed to the frame body 40 by the lock mechanism. In this way, the package does not drop during traveling and is not removed by a third party who is not the recipient.

The traveling controller 120 controls the traveling mechanism 12 to travel on the set traveling route by using the map information held in the map holding unit 108 and the current position information supplied from the GPS receiver 104. Specifically, the traveling controller 120 drives the front wheel motors 36 and the rear wheel motors 38 to cause the mobile robot 10 to travel to the destination.

The sensor data processor 106 acquires information on objects existing around the mobile robot 10 based on the detection data by the object detection sensor 34 and the image captured by the camera 50, and provides the information to the traveling controller 120. A target object includes a static object, such as a structure or a gutter, that hinders traveling, and an object (movable object) that can move, such as a person or another mobile robot 10. The traveling controller 120 determines a traveling direction and a traveling speed to avoid collision with another object, and controls driving of the front wheel motors 36 and the rear wheel motors 38.

When the mobile robot 10 reaches the destination where the user who is the recipient is, the traveling controller 120 stops driving the motors. The user has previously acquired a passcode for unlocking the package destined for the user from an external server device. When the user transmits the passcode to the mobile robot 10 using a portable terminal device such as a smartphone, the communication unit 52 receives the passcode for unlocking, and the information processor 126 unlocks the package. At this time, the movement controller 122 drives the standing actuator 30 to cause the mobile robot 10 to take an upright standing position. In this way, the user recognizes that the package can be received, and can easily pick up the package loaded on the main body 14, which is destined for the user himself or herself. When the package is received by the user, the traveling controller 120 travels autonomously to the next destination.

The basic action mode of the mobile robot 10 has been described above, but the mobile robot 10 can also perform actions in other action modes. There are various action modes of the mobile robot 10, and a program for implement each action mode may be preinstalled. When the action mode is set, the mobile robot 10 acts in the set action mode. Hereinafter, a monitoring support action mode will be described in which the mobile robot 10 rushes to an area where a disaster is likely to occur and acts as an image capturing robot that transmits images of the area to a monitoring device.

Monitoring Support Action Mode

FIG. 7 illustrates an outline of the monitoring system 1 of the embodiment. The monitoring system 1 includes a plurality of mobile robots 10a, 10b, 10c, 10d having an autonomous traveling function, and monitoring cameras 150a, 150b, 150c for capturing images of rivers, roads, and the like (hereinafter, unless otherwise specified, the “monitoring cameras 150”), and a monitoring device 200.

The monitoring device 200 is communicably connected to the mobile robots 10 and monitoring cameras 150 through a network 2 such as the Internet. The mobile robots 10 may be connected to the monitoring device 200 through wireless stations 3 which are base stations. The monitoring cameras 150 capture images of a river or a road, and distribute the captured images to the monitoring device 200 in real time. The monitoring cameras 150 of the embodiment are fixed-point cameras, and each captures an image of the river in a fixed imaging direction. In FIG. 7, an area where each monitoring camera 150 can capture images is represented by hatching, and an area without hatching represents an area where the monitoring camera 150 cannot capture images.

FIG. 8 illustrates functional blocks of the monitoring device 200. The monitoring device 200 includes a controller 202 and a communication unit 204. The controller 202 includes an image acquisition unit 210, a robot management unit 216, a robot information holding unit 218, a monitoring camera position holding unit 220, an image analyzing unit 222, an area specifying unit 224, and an instruction unit 226, and the image acquisition unit 210 has a first image acquisition unit 212 and a second image acquisition unit 214. The communication unit 204 communicates with the mobile robot 10 and the monitoring cameras 150 through the network 2.

In FIG. 8, each of the elements described as functional blocks that perform various processes may be configured to include a circuit block, a memory (storage medium), or another LSI in terms of hardware, and is implemented by a program, or the like loaded into the memory in terms of software. Therefore, it is to be understood by those skilled in the art that these functional blocks can be implemented in various forms by hardware, software, or a combination thereof, and the disclosure is not limited thereto.

The robot management unit 216 manages the positions (latitude and longitude) of the mobile robots 10 in the monitoring system 1. The mobile robots 10 may periodically transmit position information indicating where they are located, to the monitoring device 200. In this way, the robot management unit 216 grasps the current position of each of the mobile robots 10 and stores the position information on each mobile robot 10 in the robot information holding unit 218. The robot management unit 216 periodically updates the position information of the robot information holding unit 218, and thus the robot information holding unit 218 holds the latest position information on the mobile robots 10.

The first image acquisition unit 212 acquires images captured by a plurality of the monitoring cameras 150 in real time. The monitoring camera position holding unit 220 stores the ground positions and the imaging directions of the monitoring cameras 150. The image analyzing unit 222 analyzes the images captured by the monitoring cameras 150 to grasp the current states of the monitoring target or predict the future state. The area specifying unit 224 specifies an area that needs further information from the analysis result by the image analyzing unit 222.

As illustrated in FIG. 7, when the monitoring target of the monitoring cameras 150 is a river, the image analyzing unit 222 analyzes the image acquired by the first image acquisition unit 212 and measures the amount of increase in water at a plurality of points that are being captured by the monitoring cameras 150. In this case, when the image of the specific monitoring camera 150, for example, the monitoring camera 150b is unclear and the image analyzing unit 222 cannot perform high-precision image analysis, the area specifying unit 224 determines that the information on the area where the monitoring camera 150b is responsible for image-capturing is insufficient and that accurate information of the area is needed. In addition, when the first image acquisition unit 212 cannot acquire an image from the monitoring camera 150b due to a communication failure, the same applies, and the area specifying unit 224 determines that accurate information on the area where the monitoring camera 150b is responsible for image-capturing is needed.

The area specifying unit 224 acquires the ground position and the imaging direction of the monitoring camera 150b from the monitoring camera position holding unit 220, and specifies an area that needs accurate information, that is, an area where the monitoring camera 150b is responsible for image-capturing. When the area specifying unit 224 specifies the area that needs information, the instruction unit 226 causes the communication unit 204 to transmit, to the mobile robots 10, the dispatch instruction to go to the area specified by the area specifying unit 224 (hereinafter referred to as a “monitoring area”). The dispatch instruction may include information indicating that the monitoring target is the river, together with position information of the monitoring area.

The instruction unit 226 may specify the mobile robots 10 existing near the monitoring area. The robot information holding unit 218 holds the latest position information of the mobile robots 10, and thus, the instruction unit 226 refers to the position information on the mobile robots 10 held by the robot information holding unit 218 and specifies the mobile robots 10 existing within a predetermined distance from the monitoring area. The instruction unit 226 may specify N mobile robots 10 in the order of proximity from among the mobile robots 10 existing within the predetermined distance L from the monitoring area, and transmit the dispatch instruction to the monitoring area to the specified N mobile robots 10.

The robot management unit 216 causes the robot information holding unit 218 to store information indicating that the mobile robots 10 to which the instruction unit 226 has transmitted the dispatch instruction is being dispatched. Therefore, when the area specifying unit 224 subsequently specifies another monitoring area that needs information, the instruction unit 226 may exclude, from a dispatch candidate, the mobile robot 10 with the information being held indicating that the mobile robot 10 is being dispatched, and may specify the mobile robot 10 to which the dispatch instruction is to be issued from among the mobile robots 10 that are not being dispatched.

When the communication unit 52 of the mobile robot 10 receives the dispatch instruction, the traveling controller 120 controls the traveling mechanism 12 to cause the mobile robot 10 to travel according to the dispatch instruction. Specifically, upon receiving the dispatch instruction, the traveling controller 120 sets the destination as a monitoring area, and controls the traveling mechanism 12 to cause the mobile robot 10 to travel toward the destination. When the mobile robot 10 arrives at the monitoring area, the traveling controller 120 travels to move around the monitoring area. Since the dispatch instruction includes information indicating that the monitoring target is a river, the traveling controller 120 travels along the river in the monitoring area, and the information processor 126 causes the camera 50 to capture images of the river from a nearby position. The captured image transmitter 128 transmits, to the monitoring device 200, the image captured by the camera 50, together with capture-position information indicating the captured position.

The second image acquisition unit 214 acquires an image captured by the camera 50 of the mobile robot 10 and capture-position information. The image analyzing unit 222 analyzes the image captured by the camera 50 of the mobile robot 10 to grasp the current state of the monitoring target or predict a future state of the monitoring target. The area specifying unit 224 may specify an area that needs information from the analysis result of the image analyzing unit 222 and the capture-position information.

Referring to FIG. 7, the monitoring cameras 150 captures images of a river, but there are areas where the monitoring cameras 150 cannot capture images. The area specifying unit 224 specifies an area that cannot be captured by the monitoring camera 150, and the instruction unit 226 may transmit a dispatch instruction to move around the area specified by the area specifying unit 224. This allows the image acquisition unit 210 to acquire a captured image of the area that has not been sufficiently captured by the monitoring cameras 150, and thus the image analyzing unit 222 can recognize the state of the entire river (for example, the amount of increase in water) by image analysis.

The area specifying unit 224 may specify an area on which more detailed information is to be acquired. Usually, the monitoring camera 150 is installed at a position away from the river to capture images of a wide range, and therefore the resolution of the image of the river being captured is mostly low. Therefore, in order to more accurately measure the amount of increase in water, the mobile robot 10 may be dispatched near the river, and the image captured by the camera 50 may be transmitted to the monitoring device 200. Making it possible to accurately measure the amount of increase in water, the image analyzing unit 222 can predict, for example, the possibility of flooding with high accuracy.

The disclosure has been described based on the embodiment. It should be noted that the embodiment is merely an example, and it is understood by those skilled in the art that various modifications can be made to the combination of the components and processes thereof, and that such modifications are also within the scope of the disclosure.

In the embodiment, the monitoring camera position holding unit 220 stores the ground position and the imaging direction of each of the monitoring cameras 150, but may store information on an area where each of the monitoring cameras 150 is responsible for image-capturing. In the embodiment, the area specifying unit 224 acquires the ground position and the imaging direction of the monitoring camera 150b from the monitoring camera position holding unit 220 and specifies the area that needs accurate information, but when the monitoring camera position holding unit 220 holds the information on the area of responsibility of the monitoring camera 150b, the area specifying unit 224 may specify an area that needs accurate information from the information on the area of responsibility.

In the monitoring system 1 of the embodiment, the monitoring device 200 monitors the state of a river, but may monitor an area where a disaster is likely to occur, such as a road, a sea, or a mountain. In addition to the disaster, the monitoring device 200 may be used for watching and monitoring elderly people and children.

What is claimed is:

1. A monitoring method comprising:
acquiring an image captured by a monitoring camera;
analyzing the image captured by the monitoring camera;
specifying an area that needs information from a result of the analysis;
transmitting, to a mobile robot, a dispatch instruction to the specified area;
acquiring an image captured by a camera of the mobile robot; and
analyzing the image captured by the camera of the mobile robot.

2. The monitoring method according to claim 1, further comprising specifying an area that needs information from a result of the analysis of the image captured by the camera of the mobile robot and capture-position information.

3. The monitoring method according to claim 1, further comprising:
specifying an area of which image-capturing by the monitoring camera is not possible; and
transmitting a dispatch instruction to move around the area of which image-capturing by the monitoring camera is not possible.

4. A monitoring system comprising:
a plurality of mobile robots; and
a monitoring device, wherein:
the mobile robot includes;
a camera;
a traveling controller configured to control a traveling mechanism according to a dispatch instruction transmitted from the monitoring device to cause the mobile robot to travel; and
a captured image transmitter configured to transmit, to the monitoring device, an image captured by the camera together with capture-position information indicating a position where the image has been captured; and
the monitoring device includes;
a first image acquisition unit configured to acquire an image captured by a monitoring camera;
a camera position holding unit configured to store an installation position of the monitoring camera;
an analyzing unit configured to analyze the image acquired by the first image acquisition unit;
a specifying unit configured to specify an area that needs information from the analysis result by the analyzing unit;
an instruction unit configured to transmit, to the mobile robot, a dispatch instruction to the area specified by the specifying unit; and
a second image acquisition unit configured to acquire an image captured by the camera of the mobile robot and capture-position information.

5. The monitoring system according to claim 4, wherein:
the analyzing unit is configured to analyze the image acquired by the second image acquisition unit; and
the specifying unit is configured to specify an area that needs information, from the analysis result by the analyzing unit and the capture-position information.

6. The monitoring system according to claim 4, wherein:
the specifying unit is configured to specify an area of which image-capturing by the monitoring camera is not possible; and
the instruction unit is configured to transmit a dispatch instruction to move around the area specified by the specifying unit.

7. A non-transitory computer readable storage medium that stores a computer program executable by a processor to implement the monitoring method according to claim 1.
